(19) United States
(12) Patent Application Publication
(10) Pub. No.: US 2011/0150554 A1
(43) Pub. Date: Jun. 23, 2011

(54) TAPE PRINTER

(76) Inventor: Leonid Shpigel, Cape Town (ZA)

(21) Appl. No.: 13/060,343

(22) PCT Filed: Aug. 28, 2009
(86) PCT No.: PCT/ZA09/00078

§ 371 Date: Feb. 23, 2011

(30) Foreign Application Priority Data
Sep. 1, 2008 (ZA) 2008/07478

(51) Int. Cl. B41J 15/04

(52) U.S. Cl. 400/613

(57) ABSTRACT

A printing apparatus is provided that has a roller for dispensing adhesive tape and a printing wheel in association with an ink reservoir, the tape being presented with its adhesive surface presented to the printing wheel for the printing to be applied to the adhesive surface; and thence is reversed so that the adhesive surface with the printing can be applied to a substrate.

### TECHNICAL FIELD OF THE INVENTION

This invention relates to apparatus for printing on adhesive tape and, in particular to printing on the adhesive surface of the tape.

### BACKGROUND ART

I have disclosed apparatus in my Patent Application WO 061356 for security sealing that includes means for adhering a printed strip between the tape and a substrate, such as a container, the printed strip being visible through a transparent zone in the tape—preferably in the centre thereof. Any tampering of the container will result in damage to the strip and this will be observable so that steps can be taken to investigate the tampering.

The apparatus involves a roller for applying the strip and it is an object of the present invention to dispense with the use of such a roller so that the cost of the apparatus is conveniently reduced and the printing process substantially simplified.

It is not desirable for direct printing to be applied to the top surface of the tape because of the poor adhesion of certain inks to plastic surfaces and the printing may be erased easily and there are difficulties involved in applying printing to the adhesive surface of the tape. It is an object of the present invention to provide apparatus that effectively applies printing to the adhesive surface of the tape.

U.S. Pat. No. 5,784,959 was the main citation in the PCT Application No. PCT/ZA2009/000078 from which the present application is derived. That patent describes a printer for printing on the adhesive side of a clear tape, the flow of ink being controlled by a compressor. The present invention aims to avoid the use of such ungainly apparatus.

### DISCLOSURE OF THE INVENTION

According to the present invention apparatus is provided that includes a printing wheel or the like with ink feeding means, the wheel being located for applying printing to the underside of an adhesive tape prior to the application of the tape to a substrate.

Thus, the printing wheel is presented with the adhesive side of the tape as it is wound out from a roller and the tape is then reversed in direction so that the adhesive surface is presented to the substrate. The presentation of the adhesive surface of the tape to the printing wheel may be effected by means of a roller which also serves to reverse the direction of the tape after printing. In other words, the non-adhesive surface passes over the reversing roller and the adhesive surface is available to be applied to the substrate.

In a preferred form of the invention an intermediate roller is provided to guide and/or locate and/or tension the adhesive surface correctly in relation to the printing wheel.

The adhesive surface should not adhere to the intermediate roller. Thus, it may be coated with a non-sticking composition such as a silicone and/or the surface may be knurled, corrugated or otherwise reduced in area contact with the adhesive surface.

The means for feeding ink may comprise an absorbent roller in communication with an ink reservoir. This means may be removable for re-inking or changing the means; and may be adjustable in the frame to provide the correct pressure on the printing wheel.

The printing wheel may be replaceable by other wheels having different printing content or width or other necessary difference.

The printing wheel may be made from any suitable material that is capable of receiving ink and transferring it to the surface of the tape without smudging.

It will be appreciated that the printing wheel may be adapted to achieve multicoloured printing. Alternatively a plurality of printing rollers may be provided for the same purpose. A plurality of ink rollers and reservoirs may be provided for either of these purposes.

Printing changes may be effected by merely changing a peripheral printing strip for the wheel.

The apparatus may also include a roller or wheel that is adapted to form perforations across the tape as described in my South African Patent Application 2007/06992.

### BRIEF DESCRIPTION OF THE DRAWINGS

An embodiment of the invention is described below with reference to the accompanying photograph and drawings, in which:

FIG. 1 is a side view with the near side plate removed for illustrative purposes,

FIG. 2 is a top view,

FIG. 3 is a rear view, and

FIG. 4 is an angled front view.

### DETAILED DESCRIPTION OF THE PREFERRED EMBODIMENT

The photograph illustrates the general concept of the invention in the form of a hand held tape applicator. It will be appreciated that the invention is also applicable to semi or completely automatic apparatus.

A frame 10 carries a handle 12 by means of which a desired pressure may be applied to the adhesive tape 14 via the pressure roller 20 when applying the tape to a particular substrate. The tape is carried on a roller 16 and passes over a roller 18 with the adhesive surface of the tape in contact with that roller. This roller provides tensioning of the tape as well as serving as a guide. In order to avoid undue adhesion of the tape to the surface of the roller, the surface may be coated with a non-stick composition such as a silicone and/or the roller is knurled or corrugated to reduce the contact area and, therefore, the degree of adhesion,

The tape then passes over roller 20 where a printing operation is achieved on the adhesive face of the tape (see below) and then reverses to exit the device in the direction of the arrow 100. Pressure is applied to the tape by means of the handle 12 so that the tape is adhesively applied to a substrate 24.

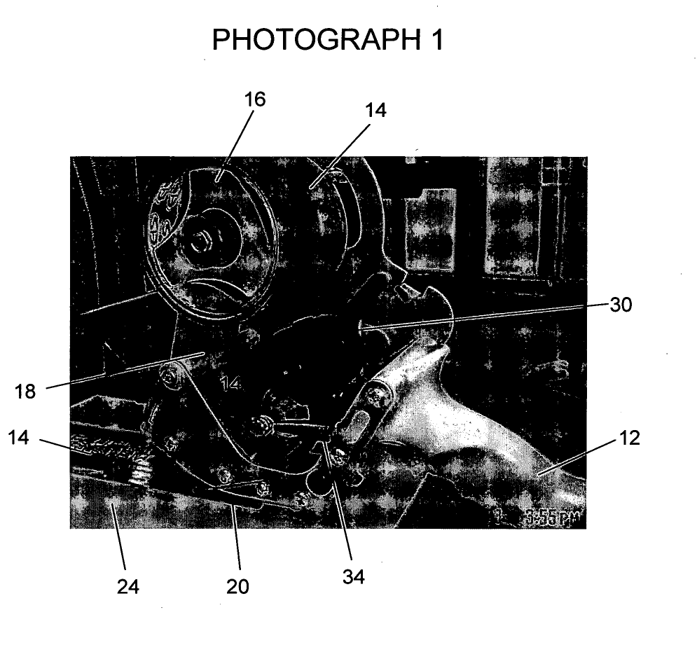

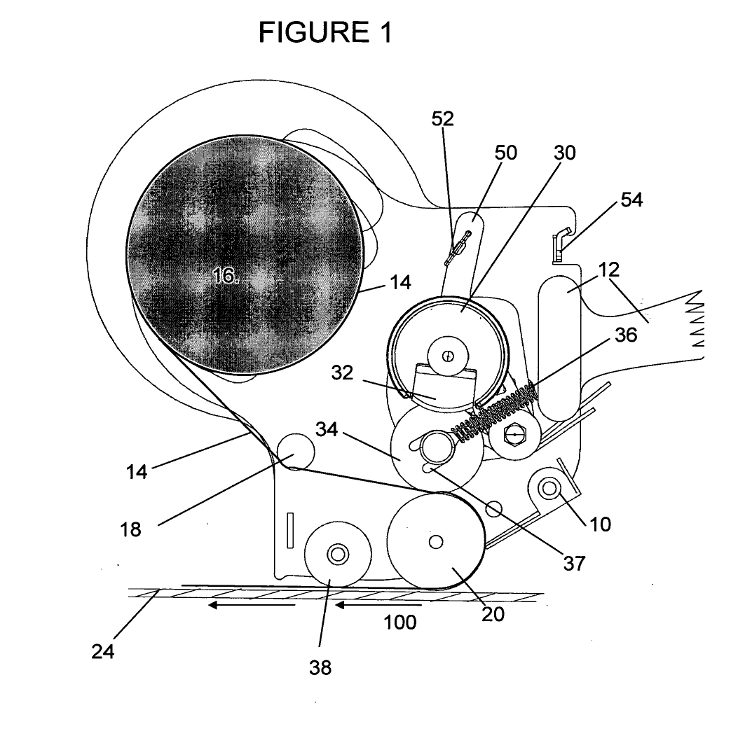

Turning to FIG. 1, an inking and printing station is provided in the form of a reservoir 30 which has a window 32 for transferring ink from an inking pad to a printing roller 34 which carries chosen printed information on its peripheral surface. The printing roller is supported by a compression balancing spring 36 with a forked member 37 engaging the axle thereof. When it is required to disengage the printing roller, for example during replacement of the reservoir or inking pad, the spring 36 is merely pulled back against the compression for the fork to be disengaged from the axle.

The tape is finally perforated so that any tampering or temporary removal of the tape is immediately observable, the perforations being applied by means of spiked roller 38.

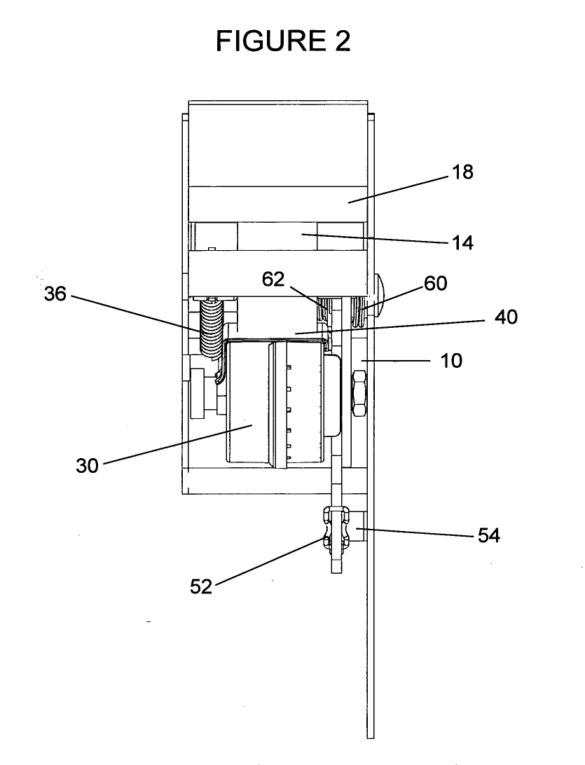

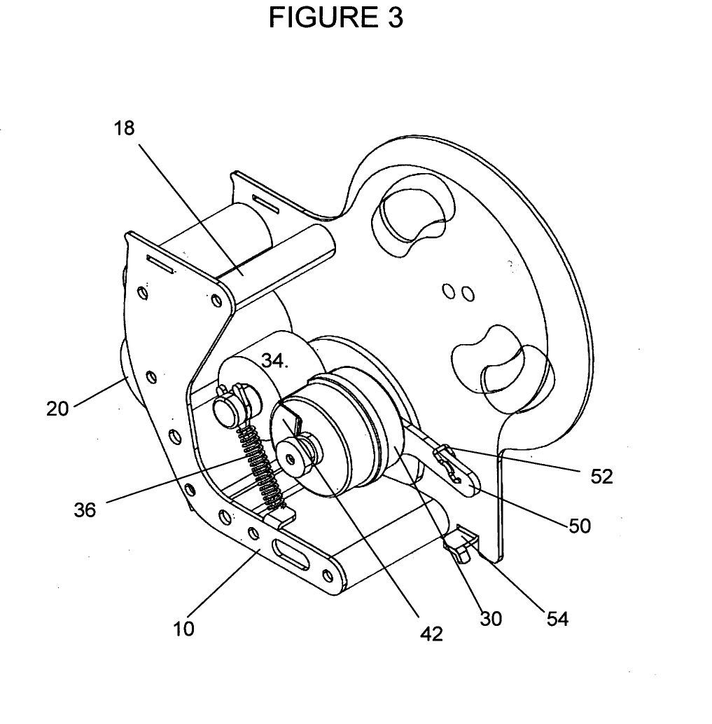

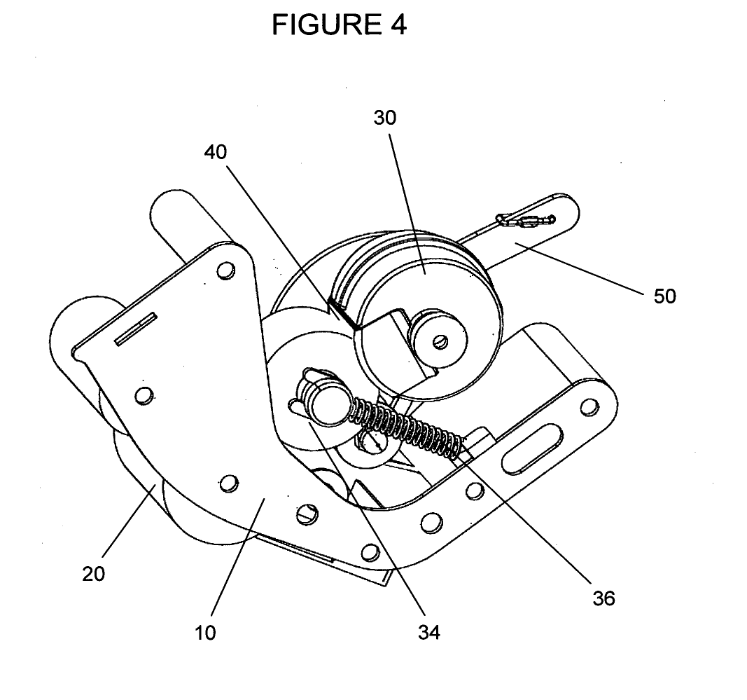

In FIG. 2, the ink reservoir is shown with an inking pad 40 that transfers the ink from the reservoir to the printing roller 34.

The reservoir carries an ink cartridge that has an ink roller. The reservoir includes a window which has a cover 42 which is discarded before use. When the ink has been used up the cartridge is replaced with a new one, the cover of the new cartridge being discarded before use.

Above the roller 20 is an inking arrangement comprising the printing wheel 34 that is in contact with an inking pad 40 of an ink reservoir 30.

As the tape is drawn from the roller 16 and over the knurled roller 18 it comes into contact with the printing wheel that has printed information on its peripheral surface, the degree of contact being predetermined to achieve the best results in so far as printing quality is concerned.

As the frame is drawn from left to right, the adhesive tape is drawn past the printing wheel, over the reversing pressure roller 20 and then applied with its adhesive surface downwards on to a substrate such as a box or other container.

A release lever 50 is provided to release the printing wheel from the tape and also separates the inking pad from the printing wheel. This enables the device to be used in circumstances where printing is not required. The lever has a clip 52 that may engage with formation 54 so that it can be held in the non-printing mode.

A spring 60 serves to adjust the pressure of the inking pad against the printing wheel, while spring 62 applies pressure between the printing wheel and the tape.

The apparatus may also include a roller or wheel 38 that is adapted to form perforations across the tape as described in my South African Patent Application 2007/06992.

1-12. (canceled)

13. Printing apparatus for applying characters to an adhesive tape to be applied to a substrate for security purposes including winding means for the tape from a roller via an intermediate roller to an ink-absorbent printing roller the printing roller being in direct communication with an ink reservoir, and the roller being adapted to transfer the absorbed ink to the adhesive side of the tape.

14. The apparatus according to claim 13 in which the intermediate roller is adapted to provide a guide and tension for the tape for correct location and tension of the tape presented to the printing roller.

15. The apparatus according to claim 13 in which the intermediate roller has a surface adapted to avoid the adhesive side adhering thereto.

16. The apparatus according to claim 14 in which the intermediate roller has a surface adapted to avoid the adhesive side adhering thereto.
